(19) United States
(12) Patent Application Publication
(10) Pub. No.: US 2025/0017421 A1
(43) Pub. Date: Jan. 16, 2025

(54) MOBILE FRYER SYSTEM

(71) Applicant: CFA Properties, Inc., Atlanta, GA (US)

(72) Inventors: Chris HALFORD, Atlanta, GA (US); Scott HERDIC, Newnan, GA (US)

(21) Appl. No.: 18/767,420

(22) Filed: Jul. 9, 2024

Related U.S. Application Data
(60) Provisional application No. 63/512,821, filed on Jul. 10, 2023.

(51) Int. Cl. A47J 37/12; F02G 5/02

(52) U.S. Cl. CPC A47J 37/129; A47J 37/1228; A47J 37/1257; A47J 37/128; F02G 5/02

(57) ABSTRACT

Mobile fryer systems, cooking vessels, heated oil reservoirs, and methods of operating same to conduct cooking cycles are disclosed. An example mobile fryer system includes one or more cooking vessels configured to cook one or more food items via a cooking cycle, each of the one or more cooking vessels comprising a locking lid; a heated oil reservoir defining an enclosure, the enclosure comprising cooking oil; and one or more conduits fluidly connecting the heated oil reservoir to each of the one or more cooking vessels.

### CROSS-REFERENCE TO RELATED APPLICATIONS

This application claims priority to and benefit of U.S. Provisional Patent Application No. 63/512,821, filed Jul. 10, 2023, the contents of which are incorporated by reference herein in their entirety.

### TECHNOLOGICAL FIELD

Example embodiments of the present disclosure relate generally to fryer systems and, more particularly, to mobile fryer systems for food preparation in a moving vehicle.

### BACKGROUND

The food service industry relies upon quickly providing customers with freshly prepared food items. This goal is relatively straight-forward when a customer orders a food item at a food service establishment given the relatively short time between preparing the food item and consumption by the customer. Many food service establishments prepare certain food items and transport these items to customers at other locations. By way of example, to provide food items to customers at locations other than a brick-and-mortar establishment, some food service companies may maintain establishments and/or equipment to prepare the food on-site of the customer or a satellite location (e.g., food trucks, festival booths, pop-up stores, or the like). However, a substantial amount of preparation time is often incurred to assemble such an establishment and/or equipment (e.g., commercial fryers, cooking surfaces, or the like) on-site in order to be able to begin cooking the food items. Further time-consuming activities, such as cooling and draining cooking oil from a fryer apparatus in a food truck prior to moving the food truck or disassembling a fryer apparatus used in a festival booth or pop-up store before transporting the fryer apparatus to another location, may also be necessary in order to protect the operator during transit.

By way of another example, food delivery services are often used to transport food items previously-prepared at the food service establishment to ultimately be served to customers at another location. However, due to the substantial amount of transit time often incurred when transporting previously-prepared food items, food items are frequently delivered that are soggy or otherwise unappealing to the customer.

Applicant has identified a number of deficiencies and problems associated with conventional systems and methods for safely providing and/or delivering freshly prepared food items to a customer at a location other than a brick-and-mortar food service establishment. Through applied effort, ingenuity, and innovation, many of these identified problems have been solved by developing solutions that are included in embodiments of the present disclosure, many examples of which are described in detail herein.

### BRIEF SUMMARY

Example embodiments of the present disclosure are directed to apparatuses, assemblies, methods, and associated mobile fryer systems for food preparation in a moving vehicle. In accordance with one exemplary embodiment of the present disclosure, a mobile fryer system is provided, the mobile fryer system comprising one or more cooking vessels configured to cook one or more food items via a cooking cycle, each of the one or more cooking vessels comprising a locking lid; a heated oil reservoir defining an enclosure, the enclosure comprising cooking oil; and one or more conduits fluidly connecting the heated oil reservoir to each of the one or more cooking vessels.

In some embodiments, each of the one or more cooking vessels comprises a corresponding cooking vessel heating element. In certain further embodiments, at least a first cooking vessel is configured to be adjusted to a different cooking temperature than a second cooking vessel via the respective cooking vessel heating elements.

In some embodiments, at least one of the one or more cooking vessels comprises an inlet/outlet port, the inlet/outlet port configured to control a flow of the cooking oil into the cooking vessel from the heated oil reservoir, via the one or more conduits. In certain further embodiments, the inlet/outlet port is configured to control a flow of the cooking oil out of the cooking vessel to the heated oil reservoir, via the one or more conduits.

In some embodiments, the mobile fryer system is installed in or attached to a motor vehicle. In certain further embodiments, one or more segments of the cooking cycle are configured to occur while the motor vehicle is in transit. In still other embodiments, the heated oil reservoir is configured to use waste heat from the motor vehicle to heat, at least in part, the cooking oil.

In some embodiments, the mobile fryer system further comprises a gantry retrieval arm and a gantry drive system operably coupled with the gantry retrieval arm, the gantry drive system configured to cause movement of the gantry retrieval arm. In certain embodiments, the gantry retrieval arm is configured to engage a corresponding carrier for the automated placement and removal of the food items into and out of the one or more cooking vessels.

In accordance with another exemplary embodiments, a method of operating a mobile fryer system comprising at least one cooking vessel, each cooking vessel comprising an inlet/outlet valve is provided, the method comprising with the inlet/outlet valve closed, opening a lid of the cooking vessel and placing one or more food items in the cooking vessel; closing and locking the lid; opening the inlet/outlet valve and flowing cooking oil into the cooking vessel from a heated oil reservoir via the inlet/outlet valve; closing the inlet/outlet valve and activating a cooking vessel heating element; opening the inlet/outlet valve and draining the cooking from the cooking vessel via the inlet/outlet valve of the cooking vessel; closing the inlet/outlet valve and opening an atmosphere venting valve of the cooking vessel; and unlocking and opening the lid of the cooking vessel.

In some embodiments, the mobile fryer system is installed in or attached to a motor vehicle. In certain further embodiments, at least the opening the inlet/outlet valve and flowing cooking oil into the cooking vessel from the heated oil reservoir via the inlet/outlet valve occurs while the motor vehicle is in transit.

In certain embodiments, at least the closing the inlet/outlet valve and activating a cooking vessel heating element occurs while the motor vehicle is in transit.

In certain embodiments, at least the opening the inlet/outlet valve and draining the cooking from the cooking vessel via the inlet/outlet valve occurs while the motor vehicle is in transit.

In some embodiments, the opening the atmosphere venting valve comprising opening the atmosphere venting valve to the atmosphere to relieve pressure from the cooking vessel.

In some embodiments, the cooking oil is flowed into the cooking vessel under approximately 10 psi.

In some embodiments, the lid comprises a twist-lock or quarter-turn connection. In certain embodiments, a top portion of the lid defines one or more interaction points for a corresponding drive motor to interact with and turn the lid.

In some embodiments, the placing one or more food items in the cooking vessel comprises a gantry retrieval arm configured to engage a corresponding carrier for the automated placement of the one or more food items into the cooking vessel, such automated placement occurring while the motor vehicle is in transit.

The above summary is provided merely for purposes of summarizing some example embodiments to provide a basic understanding of some aspects of the present disclosure. Accordingly, it will be appreciated that the above-referenced embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described the present disclosure in general terms, reference will now be made to the accompanying drawings, which are not necessarily drawn to scale. The components illustrated in the figures may or may not be present in certain embodiments described herein. Some embodiments may include fewer (or more) components than those shown in the figures.

FIG. 1 illustrates a schematic representation of a mobile fryer system in accordance with some example embodiments described herein.

FIGS. 2A and 2B illustrate example cooking vessels in accordance with some example embodiments described herein.

FIGS. 3A and 3B illustrate an example heated oil reservoir in accordance with some example embodiments described herein.

FIGS. 4A-F illustrate another mobile fryer system in accordance with some example embodiments described herein.

FIGS. 5A-5E illustrate example cooking vessels in accordance with some example embodiments described herein.

FIG. 6 illustrates an example heated oil reservoir in accordance with some example embodiments described herein.

FIGS. 7A and 7B illustrate an example flowchart for operating a mobile fryer system in accordance with some example embodiments described herein.

FIG. 8 illustrates an example flowchart for operating a mobile fryer system in accordance with some example embodiments described herein.

FIG. 9 illustrates an example gantry retrieval arm and carrier for use in a mobile fryer system in accordance with some example embodiments described herein.

FIG. 10 illustrates an example flow diagram of a mobile fryer system in accordance with some example embodiments described herein.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. For example, although described herein with reference to a mobile system and/or a moving vehicle, the present disclosure contemplates that the fryer system of the present application may be used “in line” in a restaurant or in a prepared food vending machine. The present disclosure also contemplates that the fryer system may also be used in conjunction with other food preparation systems. For example, additional modules, such as a food item breading module, an assembly module, and/or a packaging module, may be added to the mobile fryer system described herein. Like numbers refer to like elements throughout.

### Example Mobile Fryer Systems

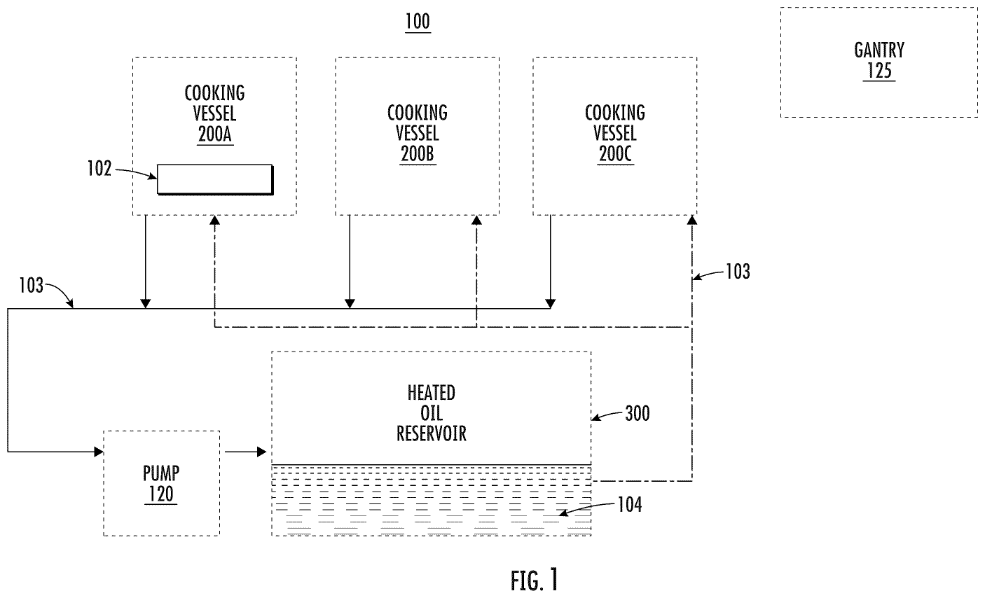

With reference to FIG. 1, an example mobile fryer system 100 according to one example embodiment is illustrated. As described hereafter, the mobile fryer system 100 may be installed in or attached to a motor vehicle such that the system 100 may be used to cook food item(s) 102 (e.g., raw and/or partially cooked) via a cooking cycle (e.g., a pressurized cooking cycle or a non-pressurized cooking cycle), one or more of the segments of the cooking cycle configured to occur while in transit to a delivery location. As shown, the mobile fryer system 100 may include one or more cooking vessels 200 (e.g., cooking vessel 200A, cooking vessel 200B, cooking vessel 200C, etc.) configured to cook the food item(s) 102, a heated oil reservoir 300 configured to heat and/or store cooking oil 104, and one or more conduits 103 fluidly connecting the various components of the mobile fryer system 100. In some embodiments, a mobile fryer system 100 may be further configured with sensors and/or circuitry (e.g., temperature sensors, timing circuits, and/or the like) described hereafter. In some embodiments, the mobile fryer system 100 is a mobile pressurized fryer system. Alternatively, in some embodiments, the mobile fryer system 100 is a mobile non-pressurized fryer system.

In some embodiments, the mobile fryer system 100, or one or more portion(s) thereof, is powered (and/or back-up powered) by one or more of an electrical system, a battery, a gas power generation system, an electrical/gas hybrid system, or the like. In an exemplary embodiment, the mobile fryer system 100 is electrically connected to the electrical system of the motor vehicle in which the system 100 is disposed. In some embodiments, the mobile fryer system 100, or one or more portion(s) thereof, is powered by one or more batteries electrically connected to the system 100. In still other embodiments, the mobile fryer system 100, or one or more portion(s) thereof, is powered by a gas power generation system or an electrical/gas hybrid system. Additionally or alternatively, heat (e.g., waste heat such as coolant, exhaust, brakes, etc.) from the motor vehicle may be used to preheat the cooking oil 104.

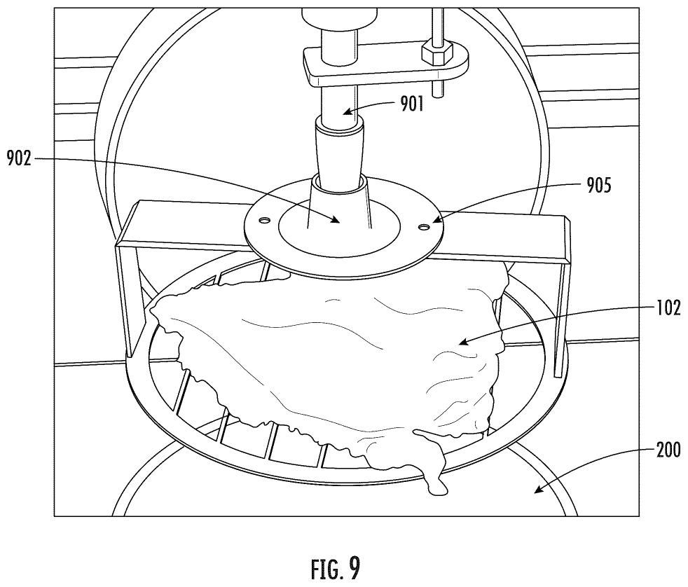

In some embodiments, the mobile fryer system 100 may further include a gantry 125 including a gantry retrieval arm and a gantry drive system operably coupled with the gantry retrieval arm, the gantry drive system configured to cause movement of the gantry retrieval arm. For example, in some embodiments, the gantry drive system may be configured to control and/or adjust the gantry retrieval arm with the assistance of one or more air cylinders, drive motors, pneumatic elements, hydraulic elements, and/or the like. The gantry 125 may be configured to engage a corresponding carrier (e.g., basket, carrier, or the like), the carrier configured for supporting the food item(s) 102, allowing for the automated placement and removal of the food item(s) 102 into and out of the cooking vessels 200. For example, as depicted in FIG. 9, in some embodiments, a distal portion of the gantry retrieval arm 901 may comprise one or more suction cup units 902, configured to be able to releasably attach to, transport, release, and/or other load and unload the corresponding carrier 905 into and/or out of one or more cooking vessels 200 configured to cook the food item(s) 102.

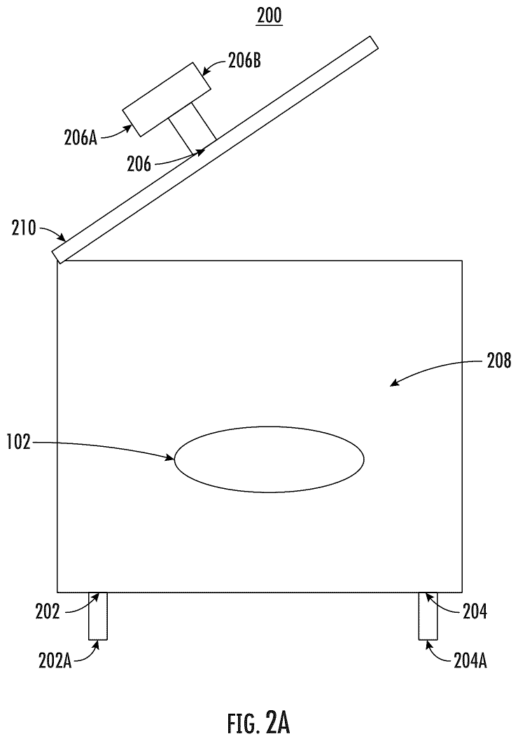

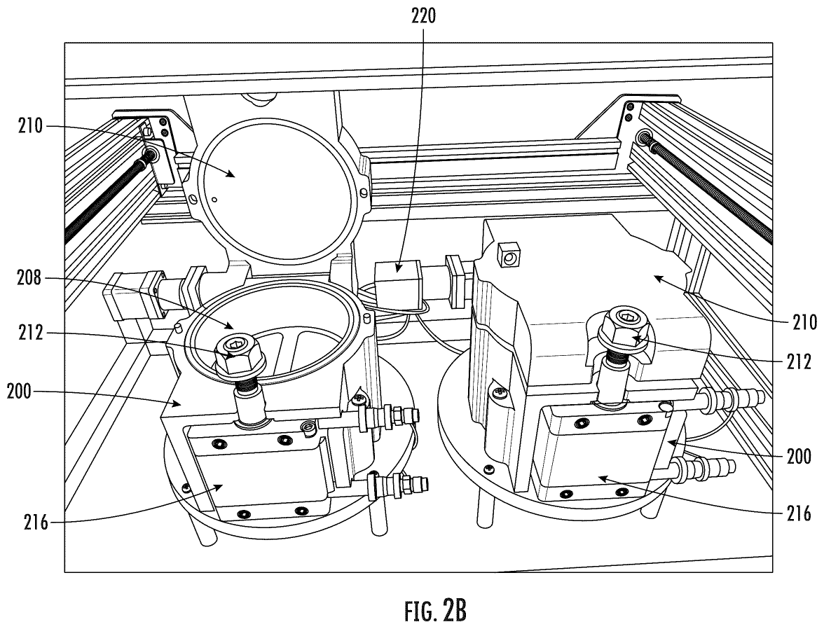

With reference to FIGS. 2A and 2B, example cooking vessel 200 is illustrated. Although three cooking vessels 200A, 200B, 200C are depicted in the mobile fryer system 100 of FIG. 1, this disclosure contemplates that any number of cooking vessels may be utilized. As shown, the cooking vessel 200 may define a housing, chamber, or other enclosure in which one or more food items 102 and/or a heat transfer medium, such as cooking oil 104, may be supported. By way of example, the cooking vessel 200 may comprise a cylindrical stainless-steel outer shell to provide rigidity to the cooking vessel 200, the outer shell defining a cooking chamber 208 within which food item(s) 102 and/or cooking oil 104 may be supported. As would be evident to one of ordinary skill in the art in light of the present disclosure, while described with reference to a cylindrical, stainless-steel outer shell, the present disclosure contemplates that the cooking vessel 200 may be formed of any material (e.g., corrosion resistant food grade or the like) and of any shape that provides sufficient rigidity and support to the embodiments of the present disclosure.

The cooking chamber 208 may further define an opening at the top of the cooking vessel 200. Although illustrated as a circular opening, the opening defined by the cooking chamber 208 (and thereby, the corresponding lid 210) may be dimensioned (e.g., sized and shaped) to provide any sufficient opening to the embodiments of the present disclosure. The opening of the cooking vessel 200 may be enclosed by a lid 210 to allow an operator (e.g., food service operator) and/or gantry to place uncooked food items 102 within or to selectively access cooked food items 102 therein. In some embodiments, the lid 210 may be a motorized lid which can be locked down with a lock 212 (e.g., using a low-profile air cylinder 216) during a cooking cycle (e.g., a pressurized cooking cycle or a non-pressurized cooking cycle) of the mobile fryer system 100. In some embodiments, the movement of the lock 212 may be controlled and/or adjusted by or with the assistance of one or more air cylinders 216, drive motors, pneumatic elements, hydraulic elements, and/or the like. In the example embodiment depicted in FIG. 2B, a low-profile air cylinder 216 may be located adjacent to and/or incorporated within an exterior wall of the cooking vessel 200, the low-profile air cylinder 216 being adapted to drive a movement of the lock 212 in relation to the lid 210. Additionally or alternatively, the lid 210 may be a twist-lock lid, which may be opened, for example, via a rotating actuator.

In some instances, the cooking vessel 200 may further include a liner, such as a polyetherimide (PEI) liner, disposed within the cooking chamber 208 (e.g., lining the interior walls of the cooking chamber 208) and configured to minimize heat loss from the cooking vessel 200. In some instances, the cooking chamber 208 of the cooking vessel 200 may further include at least one rack, shelf, or the like for supporting the one or more food items 102 therein.

With continued reference to FIGS. 2A and 2B, the cooking vessel 200 may include an inlet port 202 and an outlet port 204, fluidly connecting the cooking vessel 200 to the heated oil reservoir 300 via the conduits 103. By way of example, the inlet port 202 and the outlet port 204 may be located at or defined by the bottom surface of the cooking vessel 200. The cooking vessel 200 may further include a venting port 206 located at the top surface of the cooking vessel 200. As shown, the venting port 206 may be located in or defined by the lid 210 of the cooking vessel 200. The inlet port 202, outlet port 204, and venting port 206 may be configured to facilitate filling and draining of the cooking oil 104 from the cooking vessel 200. In some embodiments, the inlet port 202 may be connected to the heated oil reservoir 300 via inlet valve 202A and the outlet port 204 may be connected to the pump 120 (e.g., the suction side of the pump 120) via outlet valve 204A, respectively, each valve 202A, 204A (e.g., solenoid valves) directing the flow of the cooking oil 104 to/from the cooking vessel 200 via conduit(s) 103 (as depicted in FIG. 1) and/or for shutting off the flow of cooking oil 104 from/to the heated oil reservoir 300.

In still further embodiments, the venting port 206 may include two or more valves. For example, the venting port 206 may be configured as a “T”, each leg of the “T” including a valve. That is, a first leg of the “T” may couple the cooking vessel 200 to the pressurized headspace (e.g., a mixture of air and steam at approximately 10-12 psi) of the mobile fryer system 100 and a second leg may couple the cooking vessel 200 to the atmosphere. A first valve (e.g., a check valve or pressure relief valve) may be disposed in the first leg of the “T” and configured to limit maximum pressure in the mobile fryer system 100 during filling, cooking, and draining segments of a cooking cycle. That is, at any time the pressure in the cooking vessel 200 goes above the pressure in the headspace, the first valve will open to allow flow from the cooking vessel 200 to the headspace of the system to relieve such pressure. In still further embodiments, the mobile fryer system 100 may include a system safety valve such that when the pressure in the headspace goes above a system safety valve threshold, the system safety valve will open, releasing such excess pressure from the mobile fryer system 100. A second valve (e.g., a solenoid valve) may be disposed in the second leg of the “T” and configured to release (e.g., relieve) and residual pressure to the atmosphere at the end of such a cooking cycle, prior to unlocking the lid 210 of the cooking vessel 200. When these valves are closed, the cooking vessel 200 may be isolated from the heated oil reservoir 300 and the rest of the mobile fryer system 100.

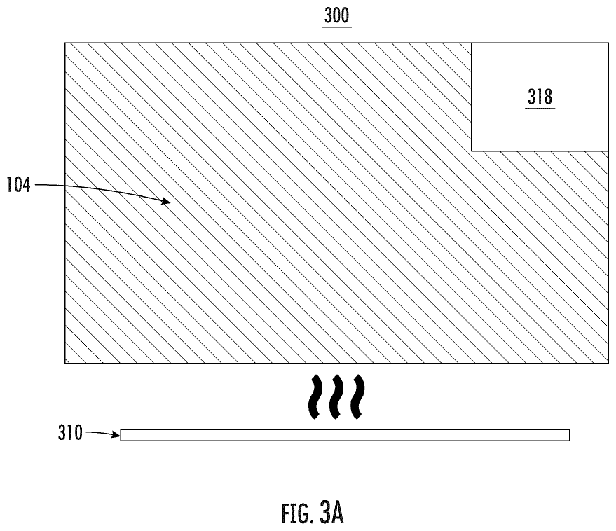

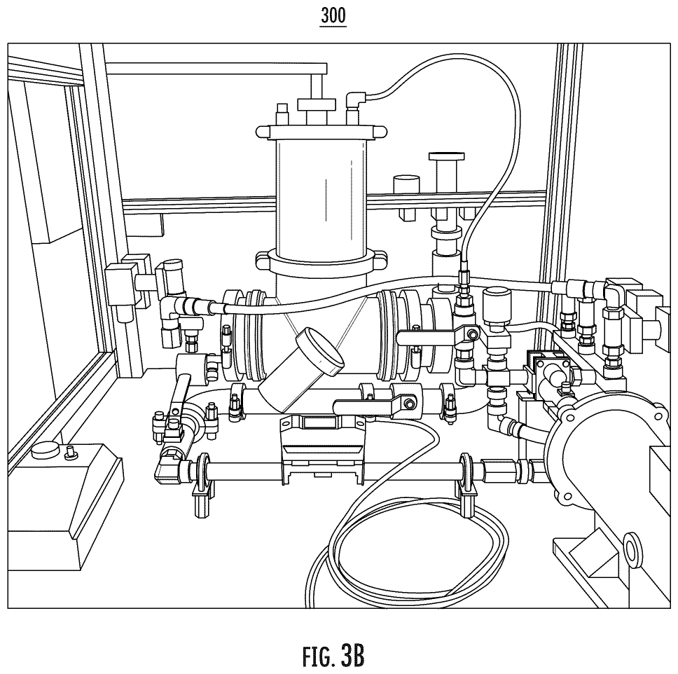

With reference to FIGS. 3A and 3B, an example heated oil reservoir 300 is illustrated. As shown, the heated oil reservoir 300 may define a housing, chamber, or other enclosure in which a heat transfer medium, such as cooking oil 104, may be heated and/or stored. By way of example, the heated oil reservoir 300 may comprise a stainless-steel outer shell for rigidity, the outer shell defining a storage chamber 308 in which cooking oil 104 may be heated and/or stored. As would be evident to one of ordinary skill in the art in light of the present disclosure, while described with reference to stainless-steel, the present disclosure contemplates that the heated oil reservoir 300 may be formed of any material that provides sufficient rigidity to the embodiments of the present disclosure.

In some embodiments, the heated oil reservoir 300 may include a heating element 310. The heating element 310 may be configured to increase to and/or maintain the requisite temperature of the cooking oil 104 within the mobile fryer system 100. In some embodiments, the heating element 310 may be configured to heat cooking oil 104 until one or more sensors (e.g., located within the heated oil reservoir 300 and/or in-line) determines that the cooking oil 104 has been sufficiently heated to the requisite cooking temperature. In this instance, heating elements are not necessary to be associated with the individual cooking vessels 200 as the heating cooking oil 104 from the heated oil reservoir 300 sufficiently cooks the food item(s) 102 via continuous circulation of the heated cooking oil 104. In still further embodiments, the heating element 310 may be configured to maintain the cooking oil 104 at a predetermined holding temperature between cooking cycles such that the cooking oil 104 retains much of its heat, thereby minimizing the amount of time and/or heat required to heat the cooking oil 104 for the next cooking cycle. Additionally or alternatively, heat (e.g., waste heat such as coolant, exhaust, brakes, etc.) from the motor vehicle may be used to preheat the cooking oil 104.

With continued reference to FIG. 3A, in some embodiments, the heated oil reservoir 300 (and/or the mobile fryer system 100) may further include a controller 318 configured to receive data from such one or more sensors (e.g., in electrical communication with the sensors). The controller 318 may be a PID controller configured to adjust the heating element 310 and/or pump(s) 120 as described herein to account for rate-of-change deviations in the temperature and/or pressure. The controller 318 of certain embodiments may be provided within a sealed compartment of the heated oil reservoir 300 (and/or the mobile fryer system 100), separate from cooking oil flow portions of the mobile fryer system 100. By keeping the controller 318 in the sealed compartment, electronic components associated with the controller 318 are isolated from cooking oil 104, humidity, and moisture that may impede proper functionality of the controller 318.

By way of example, the controller 318, in operation, may receive data from one or more sensors corresponding to the temperature of the cooking oil 104 in the heated oil reservoir 300. The controller 318 may monitor the temperature of the cooking oil 104 in order to determine if the temperature falls within one or more defined temperature ranges (e.g., cooking temperature range, holding temperature range, or the like). By way of example, one or more of the sensors may iteratively determine the temperature of the cooking oil 104 in the heated oil reservoir 300 and may transmit this data to the controller 318. The controller 318 may receive the data from the one or more sensors indicating a temperature of the cooking oil 104, may compare this data to a defined temperature range, and may determine that the data does not fall within the defined temperature range. For example, in the event the temperature value exceeds a defined cooking temperature range when cooking a food item 102 (e.g. chicken filet), the heated oil reservoir 300 (and/or the mobile fryer system 100) may decrease, turn off, or otherwise adjust the heating element 310 to lower the temperature of the cooking oil 104. By way of another example, in the event the temperature value fails to reach a defined cooking temperature range when cooking a chicken filet, the heated oil reservoir 300 (and/or the mobile fryer system 100) may increase or turn on the heating element 310 to raise the temperature of the cooking oil 104 in the heated oil reservoir 300.

Additionally or alternatively, in some embodiments, the inlet valve 202A of the cooking vessel 200 may be a temperature-sensitive valve for selectively directing the heated cooking oil 104 to the cooking vessel 200 from the heated oil reservoir 300 only when the heated cooking oil 104 is within a predefined threshold cooking temperature range. In some embodiments, such a temperature-sensitive valve may be communicably coupled to the controller 318. Additionally or alternatively, in some embodiments, the inlet valve 202A of the cooking vessel 200 may be a solenoid valve in communication with a temperature sensor (not pictured) and the controller 318.

Returning to FIG. 1, the mobile fryer system 100 may include one or more pumps 120, such as a circulation pump 120, to recirculate heated cooking oil 104 through the cooking vessel 200 during a cooking segment of a cooking cycle. In some embodiments, the cooking chamber 208 of the cooking vessel 200 may include a sump at a lower end thereof. The circulation pump 120 may be attached to the sump to recirculate the cooking oil 104 back to the heated oil reservoir 300 as it collects in the sump. In some embodiments, a filtering system (e.g., in-line) may be disposed between the cooking vessel 200 and the heated oil reservoir 300 to collect and/or filter food crumbs and other sediment from the cooking oil 104 before it is recirculated. In some embodiments, the mobile fryer system 100 may include a drain pump 120 to assist in removing and/or draining cooking oil 104 from the cooking chamber 208 during a draining segment of a cooking cycle.

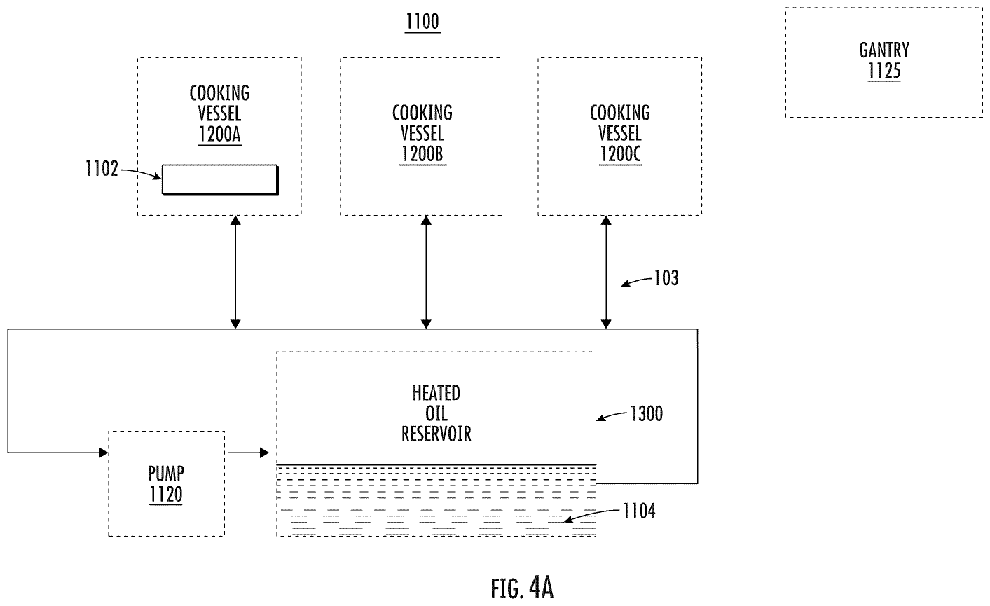

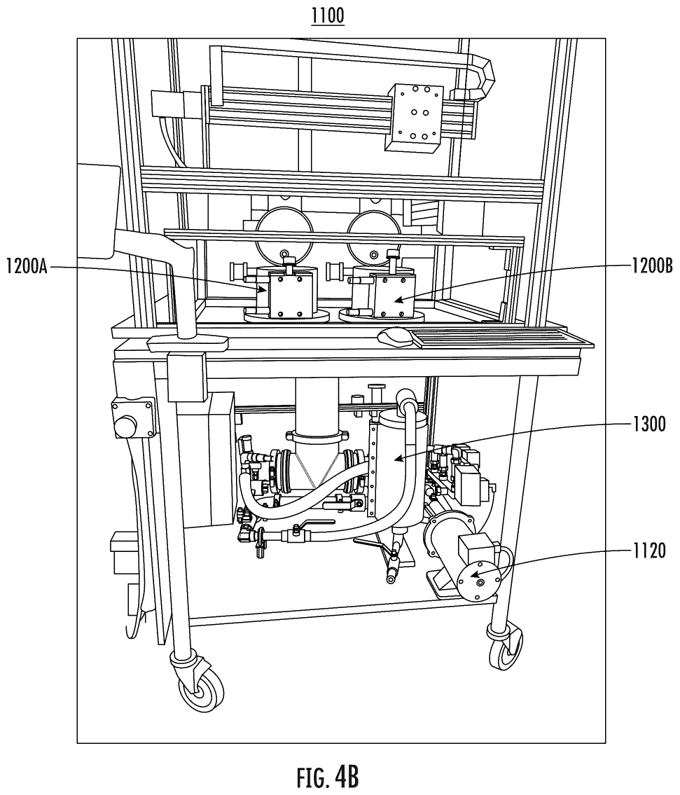

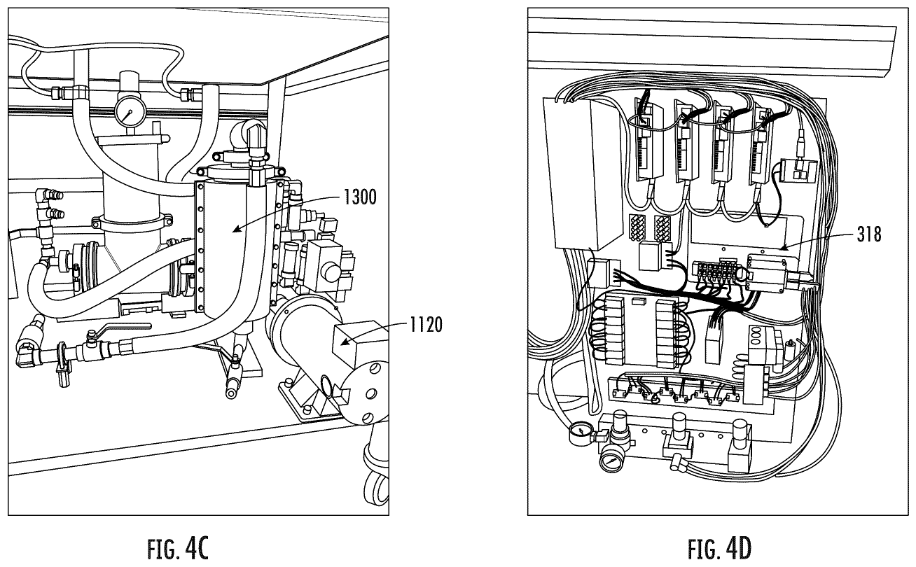

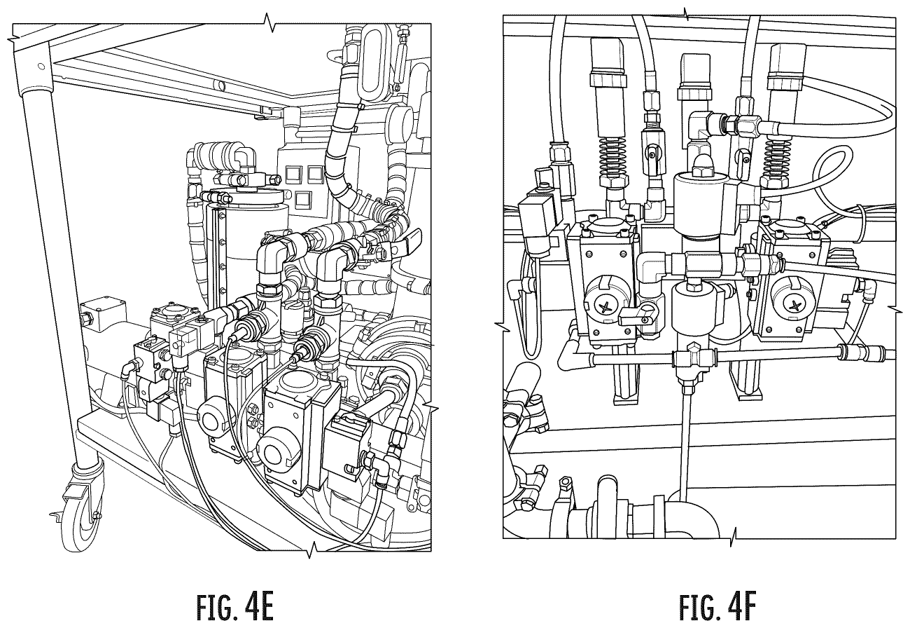

With reference to FIGS. 4A-4F, a mobile fryer system 1100 according to another example embodiment is illustrated. As described hereafter, the mobile fryer system 1100 may be installed in or attached to a motor vehicle such that the system 1100 may be used to cook food item(s) 1102 (e.g., raw and/or partially cooked) via a cooking cycle, one or more of the segments of the cooking cycle configured to occur while in transit to a delivery location. As shown, the mobile fryer system 1100 may include one or more cooking vessels 1200 (e.g., cooking vessel 1200A, cooking vessel 1200B, cooking vessel 1200C, etc.) configured to cook the food item(s) 1102, a heated oil reservoir 300 configured to heat and/or store cooking oil 1104, and one or more conduits 1103 fluidly connecting the various components of the mobile fryer system 1100. In some embodiments, a mobile fryer system 1100 may be further configured with sensors and/or circuitry (e.g., temperature sensors, timing circuits, and/or the like) described hereafter.

In some embodiments, the mobile fryer system 1100, or one or more portion(s) thereof, is powered (and/or back-up powered) by one or more of an electrical system, a battery, a gas power generation system, an electrical/gas hybrid system, or the like. In an exemplary embodiment, the mobile fryer system 1100 is electrically connected to the electrical system of the motor vehicle in which the system 1100 is disposed. In some embodiments, the mobile fryer system 1100, or one or more portion(s) thereof, is powered by one or more batteries electrically connected to the system 1100. In still other embodiments, the mobile fryer system 1100, or one or more portion(s) thereof, is powered by a gas power generation system or an electrical/gas hybrid system.

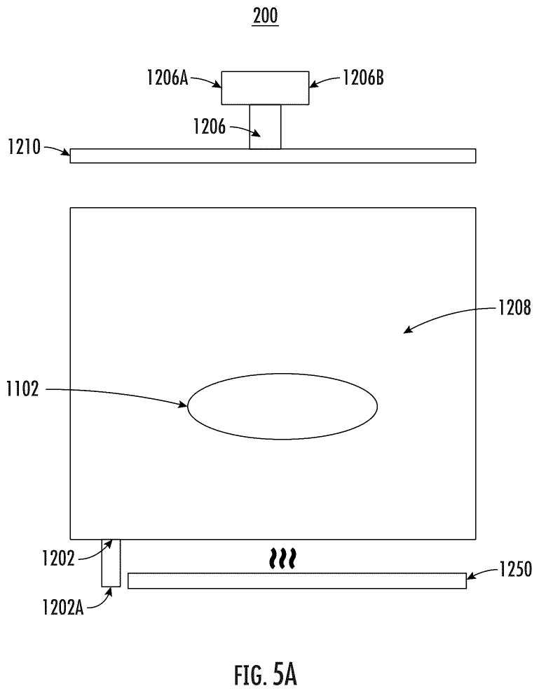

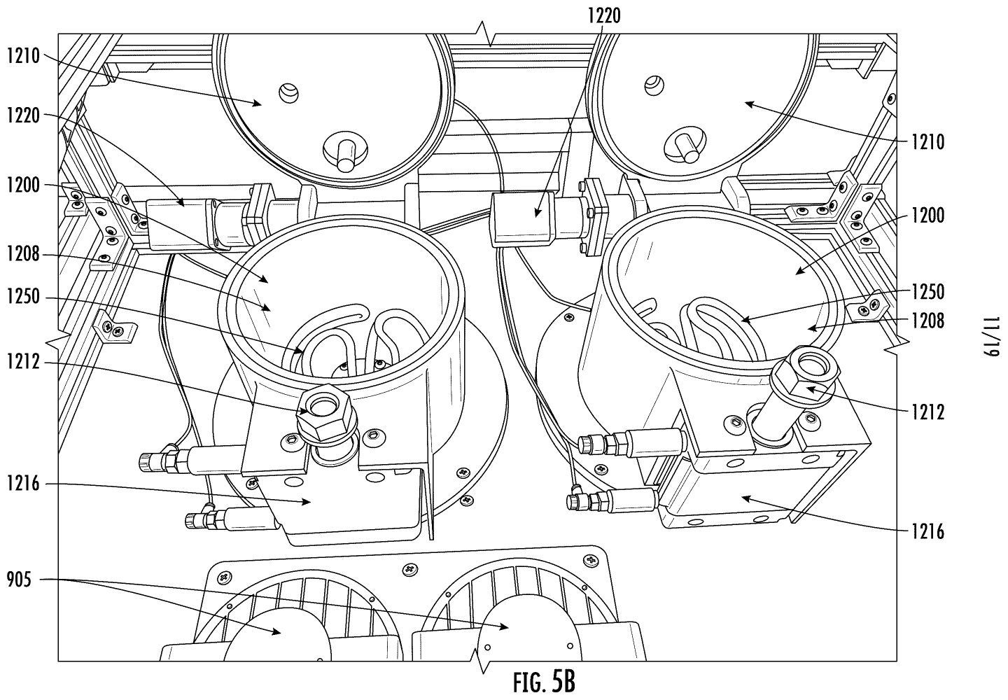

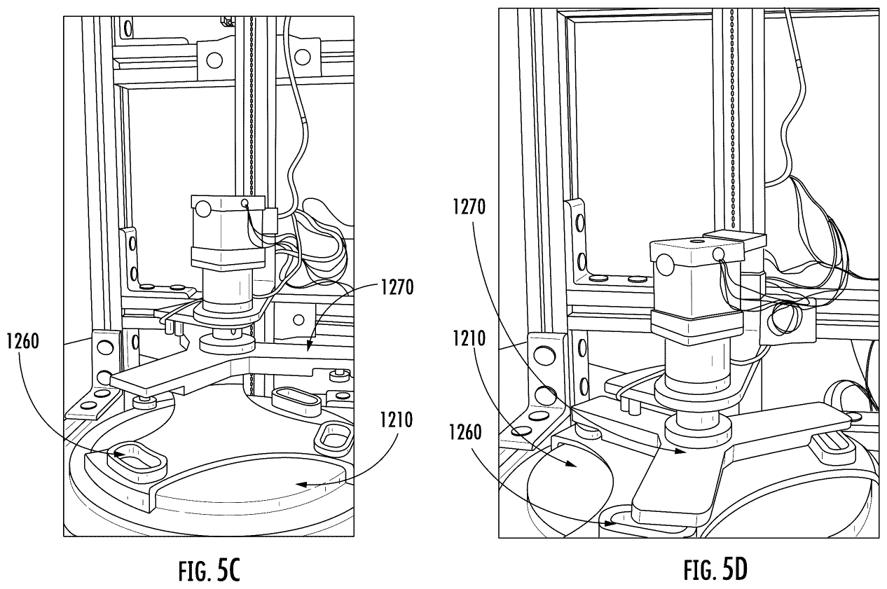

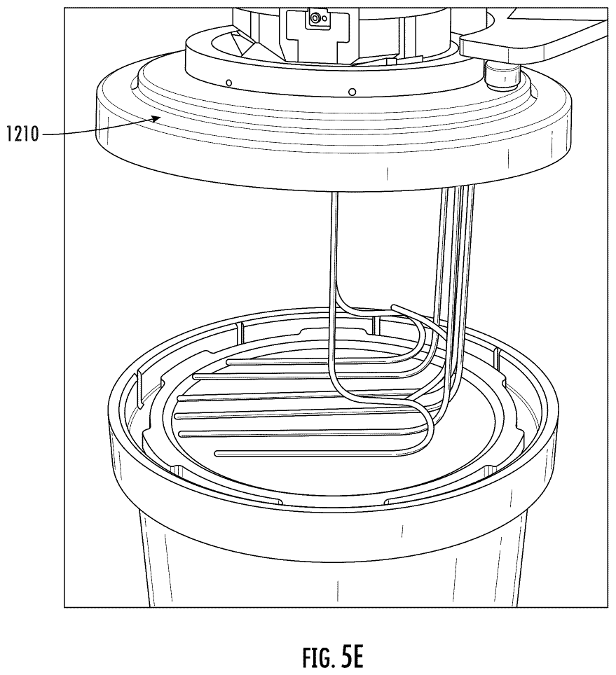

With reference to FIGS. 5A-5E, example cooking vessels 1200 is illustrated. Although three cooking vessels 1200A, 1200B, 1200C are depicted in the mobile fryer system 1100 of FIG. 4A and two cooking vessels 1200A, 1200B are depicted in the mobile fryer system 100 of FIG. 4B, this disclosure contemplates that any number of cooking vessels 1200 may be utilized. As shown, the cooking vessel 1200 may define a housing, chamber, or other enclosure in which one or more food items 1102 and/or a heat transfer medium, such as cooking oil 1104, may be supported. By way of example, the cooking vessel 1200 may comprise a cylindrical stainless-steel outer shell to provide rigidity to the cooking vessel 1200, the outer shell defining a cooking chamber 1208 within which food item(s) 102 and/or cooking oil 1104 may be supported. As would be evident to one of ordinary skill in the art in light of the present disclosure, while described with reference to a cylindrical, stainless-steel outer shell, the present disclosure contemplates that the cooking vessel 1200 may be formed of any material (e.g., corrosion resistant food grade or the like) and of any shape that provides sufficient rigidity and support to the embodiments of the present disclosure.

The cooking chamber 1208 may further define an opening at the top of the cooking vessel 1200. Although illustrated as a circular opening, the opening defined by the cooking chamber 1208 (and thereby, the corresponding lid 1210) may be dimensioned (e.g., sized and shaped) to provide any sufficient opening to the embodiments of the present disclosure. The opening of the cooking vessel 1200 may be enclosed by a lid 1210 to allow an operator (e.g., food service operator) and/or gantry to place uncooked food items 1102 within or to selectively access cooked food items 1102 therein. In some embodiments, an inner surface of the lid 1210 may define a twist-lock or quarter-turn connection that is configured for coupling the lid 1210 to the cooking vessel 1200. For example, a portion of the outer surface of the cooking vessel 1200 may define a corresponding twist-lock or quarter-turn connection that is configured for coupling the lid 1210 to the cooking vessel 1200 without the use of a motorized lid, low-profile air cylinder, drive motor, pneumatic element, hydraulic element, and/or the like during a cooking cycle of the mobile fryer system 1100. Such twist-lock or quarter turn connections may improve safety, reduce the chance of the lid 1210 opening during a cooking cycle, and/or reduce the overall number of motors and/or actuators in the mobile fryer system 1100. In some embodiments, the driver of the motorized vehicle in which the mobile fryer system 1100 is disposed or other food service operator may manually turn the lid 1210 to lock the lid 1210 to the cooking vessel 1200 and/or manually counterturn the lid 1210 to unlock the lid 1210 from the cooking vessel 1200. Additionally or alternatively, as depicted in FIGS. 5C and 5D, a top portion of the lid 1210 may define one or more interaction points 1260 for a corresponding drive motor 1270 and/or the like to interact with and turn the lid 1210. Alternatively still, the lid 1210 may be locked down using a low-profile air cylinder 1216 and lock 1212, each of the motor 1220 and low-profile air cylinder 1216 being communicably coupled to the controller 318 and/or a separate controller (e.g., cooking vessel PID controller) to be controlled by such controller.

In still other embodiments, the mobile fryer system 1100 may further include a gantry 1125 including a gantry retrieval arm and a gantry drive system operably coupled with the gantry retrieval arm, the gantry drive system configured to cause movement of the gantry retrieval arm. The gantry 1125 may be configured to automatically turn the lid 1210 to lock the lid 1210 to the cooking vessel 1200 and/or automatically counterturn the lid 1210 to unlock the lid 1210 from the cooking vessel 1200. Additionally or alternatively, the gantry 1125 may be configured to engage a corresponding carrier (e.g., basket or the like), the carrier configured for supporting the food item(s) 1102, allowing for the automated placement and removal of the food item(s) 1102 into and out of the cooking vessels 1200. Additionally or alternatively, the lid 1210 may be a twist-lock lid as discussed with respect to FIGS. 5A-5E, which may be opened, for example, via a rotating actuator. Additionally or alternatively, a bottom surface of the lid 1210 (e.g., twist lock lid) may be coupled to a carrier as depicted in FIG. 5E. In such embodiments, for example, the lid 1210 may be configured to be detached and raised above the cooking vessel 1200 (e.g., via a first gantry 1125) and another gantry 1125 or the same first gantry 1125 may be configured to place and/or remove one or more food items 1102 in/from the carrier coupled to the lid 1210, the lid 1210 thereafter lowered onto and locked to the cooking vessel 1210.

In some instances, the cooking vessel 1200 may further include a liner, such as a polyetherimide (PEI) liner, disposed within the cooking chamber 1208 (e.g., lining the interior walls of the cooking chamber 1208) and configured to minimize heat loss from the cooking vessel 1200. In some instances, the cooking chamber 1208 of the cooking vessel 1200 may further include at least one rack, shelf, or the like for supporting the one or more food items 1102 and/or the carrier therein.

In some embodiments, one or more cooking vessels 1200 of a system 1100 may each include a cooking vessel heating element 1250. For example, the cooking vessel heating element 1250 may be a resistive element or an inductive element. The cooking vessel heating element 1250 may be configured to increase to and/or maintain the requisite temperature of the cooking oil 1104 within the cooking vessel 1200 during a cooking cycle. In some embodiments, the cooking vessel heating element 1250 may be configured to heat cooking oil 1104 until one or more sensors (e.g., located within the cooking vessel 1200) determines that the cooking oil 1104 has been sufficiently heated to maintain a requisite cooking temperature. For example, the cooking vessel 1200 may receive heated cooking oil 1104 from the heated oil reservoir 1300 via a conduit 1103. The cooking vessel heating element 1250 may be configured to increase the temperature of and/or maintain the temperature of the heated cooking oil 1104 during a cooking cycle such that the heated cooking oil 1104 is sufficiently heated to cook the food item(s) 1102. For example, the cooking vessel 1200 may further include or be associated with a cooking vessel controller configured to receive data from such one or more sensors (e.g., in electrical communication with the sensors). The cooking vessel controller may be a cooking vessel PID controller configured to adjust the corresponding cooking vessel heating element 1250 to account for rate-of-change deviations in the temperature and/or pressure. Additionally or alternatively, in some embodiments, the cooking vessel controller (e.g., cooking vessel PID controller) may be configured to individually control the pressure for the corresponding cooking vessel 1200. The cooking vessel controller of certain embodiments may be provided within a sealed compartment of the cooking vessel 1200, separate from cooking oil flow portions of the cooking vessel 1200. The cooking vessel controller may additionally or alternatively be positioned separate from the cooking vessel 1200 and in communication with the sensors of the cooking vessel 1200.

Because the cooking oil 1104 retains much of its heat in the heated oil reservoir 1300, the amount of time and/or heat required to heat the cooking oil 1104 at the individual cooking vessels 1200 for the cooking cycle may be reduced or minimized. In addition, the cooking vessel heating element 1250 and/or cooking vessel PID controller at each cooking vessel 1200 enables the cooking temperature and/or temperature of the cooking oil 1104 to be individually adjusted at each cooking vessel 1200 to account for different food item(s) 1102 and/or cooking times. For example, cooking vessel 1200A may be adjusted to a different cooking temperature than cooking vessel 1200B via the respective cooking vessel heating elements 1250.

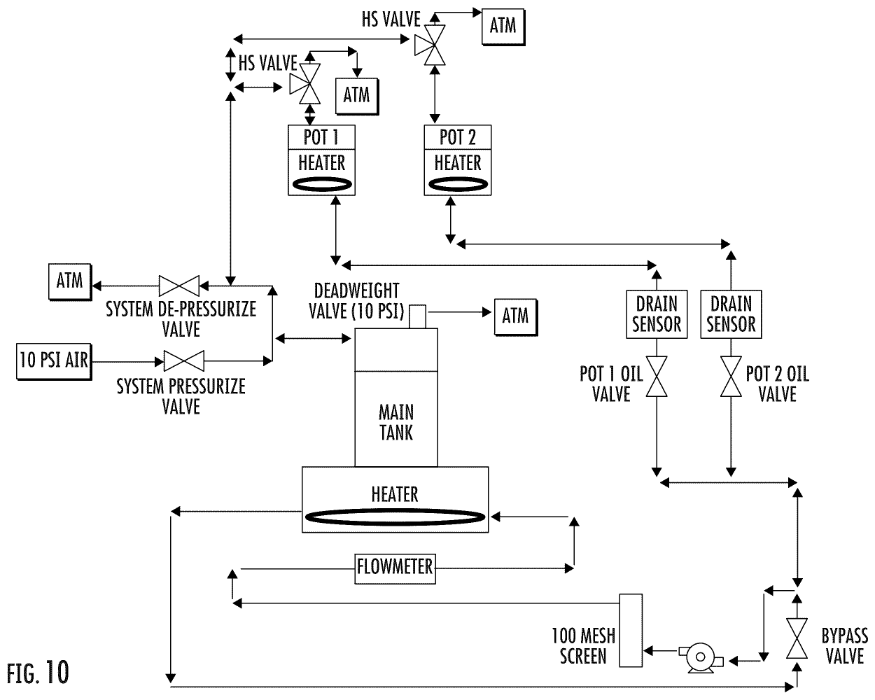

With continued reference to FIG. 5A, the cooking vessel 1200 may include an inlet/outlet port 1202, fluidly connecting the cooking vessel 1200 to the heated oil reservoir 1300 via the conduit 1103. By way of example, the inlet/outlet port 1202 may be located at or defined by the bottom surface of the cooking vessel 1200. The cooking vessel 1200 may further include a venting port 1206 located at the top surface of the cooking vessel 1200. As shown, the venting port 1206 may be located in or defined by the lid 1210 of the cooking vessel 1200. The inlet/outlet port 1202 and venting port 1206 may be configured to facilitate filling and draining of the cooking oil 1104 from the cooking vessel 1200. In some embodiments, the inlet/outlet port 1202 may be connected to the heated oil reservoir 300 via an inlet/outlet valve 1202A (e.g., a solenoid valve), the inlet/outlet valve 1202A directing the flow of the cooking oil 1104 to/from the cooking vessel 1200 via conduit 1103 (as depicted in FIG. 4A) and/or for shutting off the flow of cooking oil 104 from/to the heated oil reservoir 1300. In some embodiments, the cooking vessel(s) 1200 are at atmospheric pressure and the heated oil reservoir 1300 is pressurized, enabling filling of the cooking vessel(s) 1200 with cooking oil 1104. The pump 1102 may then be used to drain the cooking vessel(s) 1200 and/or circulate the cooking oil when the cooking vessel(s) 1200 are isolated from the heated oil reservoir 1300. In some embodiments, the fill level and/or draining time of the cooking vessel 1200 may be controlled by one or more sensors. For example, as depicted in FIG. 10, one or more sensors 1350 may be placed “in-line” between the heated oil reservoir 1300 and the individual cooking vessels (1200A, 1200B) to control the fill level and/or draining time of the individual cooking vessels (1200A, 1200B). In certain embodiments, at least one sensor 1350 is a capacitive sensor.

In still further embodiments, the venting port 1206 may include two or more valves. For example, the venting port 1206 may be configured as a “T”, each leg of the “T” including a valve. That is, a first leg of the “T” may couple the cooking vessel 1200 to the pressurized headspace (e.g., a mixture of air and steam at approximately 10-12 psi) of the mobile fryer system 1100 and a second leg may couple the cooking vessel 1200 to the atmosphere. A first valve (e.g., a check valve or pressure relief valve) may be disposed in the first leg of the “T” and configured to limit maximum pressure in the mobile fryer system 1100 during filling, cooking, and draining segments of a cooking cycle. That is, at any time the pressure in the cooking vessel 1200 goes above the pressure in the headspace, the first valve will open to allow flow from the cooking vessel 1200 to the headspace of the system to relieve such pressure. In still further embodiments, the mobile fryer system 1100 may include a system safety valve such that when the pressure in the headspace goes above a system safety valve threshold, the system safety valve will open, releasing such excess pressure from the mobile fryer system 1100. A second valve (e.g., a solenoid valve) may be disposed in the second leg of the “T” and configured to release (e.g., relieve) and residual pressure to the atmosphere at the end of such a cooking cycle, prior to unlocking the lid 1210 of the cooking vessel 1200. When these valves are closed, the cooking vessel 1200 may be isolated from the heated oil reservoir 1300 and the rest of the mobile fryer system 1100.

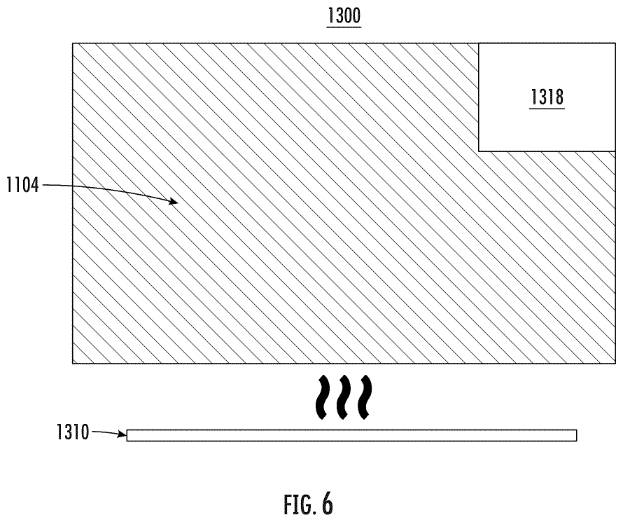

With reference to FIG. 6, an example heated oil reservoir 1300 is illustrated. As shown, the heated oil reservoir 1300 may define a housing, chamber, or other enclosure in which a heat transfer medium, such as cooking oil 1104, may be heated and/or stored. By way of example, the heated oil reservoir 1300 may comprise a stainless-steel outer shell for rigidity, the outer shell defining a storage chamber 1308 in which cooking oil 1104 may be heated and/or stored. As would be evident to one of ordinary skill in the art in light of the present disclosure, while described with reference to stainless-steel, the present disclosure contemplates that the heated oil reservoir 1300 may be formed of any material that provides sufficient rigidity to the embodiments of the present disclosure.

In some embodiments, the heated oil reservoir 1300 may include a heating element 1310. The heating element 1310 may be configured to increase to and/or maintain the requisite temperature of the cooking oil 1104 within the mobile fryer system 100. In some embodiments, the heating element 1310 may be configured to heat cooking oil 1104 until one or more sensors (e.g., located within the heated oil reservoir 1300 and/or in-line) determines that the cooking oil 1104 has been sufficiently heated to a requisite holding temperature and/or a requisite cooking temperature. For example, the heating element 1310 may be configured to maintain the cooking oil 1104 at a predetermined holding temperature between cooking cycles such that the cooking oil 1104 retains much of its heat, thereby minimizing the amount of time and/or heat required to heat the cooking oil 1104 at the individual cooking vessels 1200 for the next cooking cycle.

With continued reference to FIG. 6, in some embodiments, the heated oil reservoir 1300 (and/or the mobile fryer system 1100) may further include a controller 1318 configured to receive data from such one or more sensors (e.g., in electrical communication with the sensors). The controller 1318 may be a PID controller. The controller 1318 of certain embodiments may be provided within a sealed compartment of the heated oil reservoir 1300 (and/or the mobile fryer system 1100), separate from cooking oil flow portions of the mobile fryer system 1100. By keeping the controller 1318 in the sealed compartment, electronic components associated with the controller 1318 are isolated from cooking oil 1104, humidity, and moisture that may impede proper functionality of the controller 1318.

By way of example, the controller 1318, in operation, may receive data from one or more sensors corresponding to the temperature of the cooking oil 1104 in the heated oil reservoir 1300 and/or the individual cooking vessels 1200. The controller 1318 may monitor the temperature of the cooking oil 1104 in order to determine if the temperature falls within one or more defined temperature ranges (e.g., cooking temperature range, holding temperature range, or the like). By way of example, one or more of the sensors may iteratively determine the temperature of the cooking oil 1104 in the heated oil reservoir 1300 and may transmit this data to the controller 1318. The controller 1318 may receive the data from the one or more sensors indicating a temperature of the cooking oil 1104, may compare this data to a defined temperature range, and may determine that the data does not fall within the defined temperature range. For example, in the event the temperature value exceeds a defined cooking temperature range, the heated oil reservoir 1300 (and/or the mobile fryer system 1100) may decrease or turn off the heating element 1310 to lower the temperature of the cooking oil 1104. By way of another example, in the event the temperature value fails to reach a defined holding temperature range between cooking cycles, the heated oil reservoir 1300 (and/or the mobile fryer system 1100) may increase or turn on the heating element 1310 to raise the temperature of the cooking oil 1104 in the heated oil reservoir 1300.

Additionally or alternatively, in some embodiments, the inlet/outlet valve 1202A of the cooking vessel 1200 may be a temperature-sensitive valve for selectively directing the heated cooking oil 1104 to the cooking vessel 1200 from the heated oil reservoir 1300 only when the heated cooking oil 1104 is within a predefined threshold temperature range. In some embodiments, such a temperature-sensitive valve may be communicably coupled to the controller 1318. Additionally or alternatively, in some embodiments, the inlet valve 1202A of the cooking vessel 1200 may be a solenoid valve in communication with a temperature sensor (not pictured) and the controller 1318.

Returning to FIGS. 4A-4F, the mobile fryer system 1100 may include one or more pumps 1120, such as a circulation pump 1120, to circulate heated cooking oil 1104 to and from the cooking vessel 1200 via a conduit 1130. In some embodiments, the cooking chamber 1208 of the cooking vessel 1200 may include a sump at a lower end thereof. In some embodiments, a filtering system (e.g., in-line) may be disposed between the cooking vessel 1200 and the heated oil reservoir 1300 to collect and/or filter food crumbs and other sediment from the cooking oil 1104. For example, as depicted in FIG. 10, a mesh screen may be placed in-line between the heated oil reservoir 1300 and the cooking vessels 1200. In some embodiments, the mobile fryer system 1100 may include a drain pump 1120 to assist in removing and/or draining cooking oil 104 from the cooking chamber 1208 during a draining segment of a cooking cycle. FIGS. 4E and 4F depict example embodiments of the oil manifold and steam manifold, respectively, of a mobile fryer system 1100 of the present disclosure.

### Example Operation and Methods

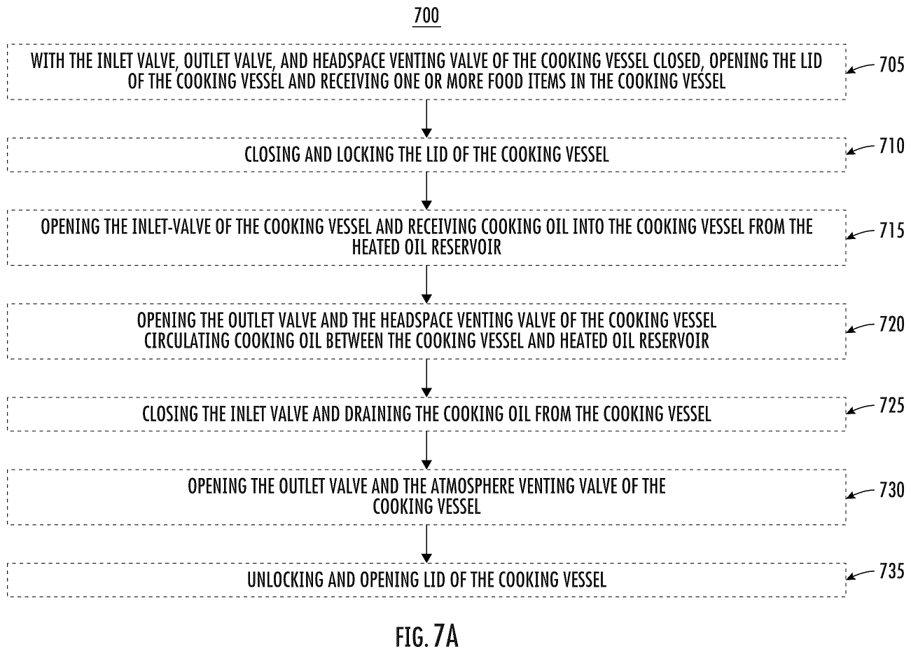

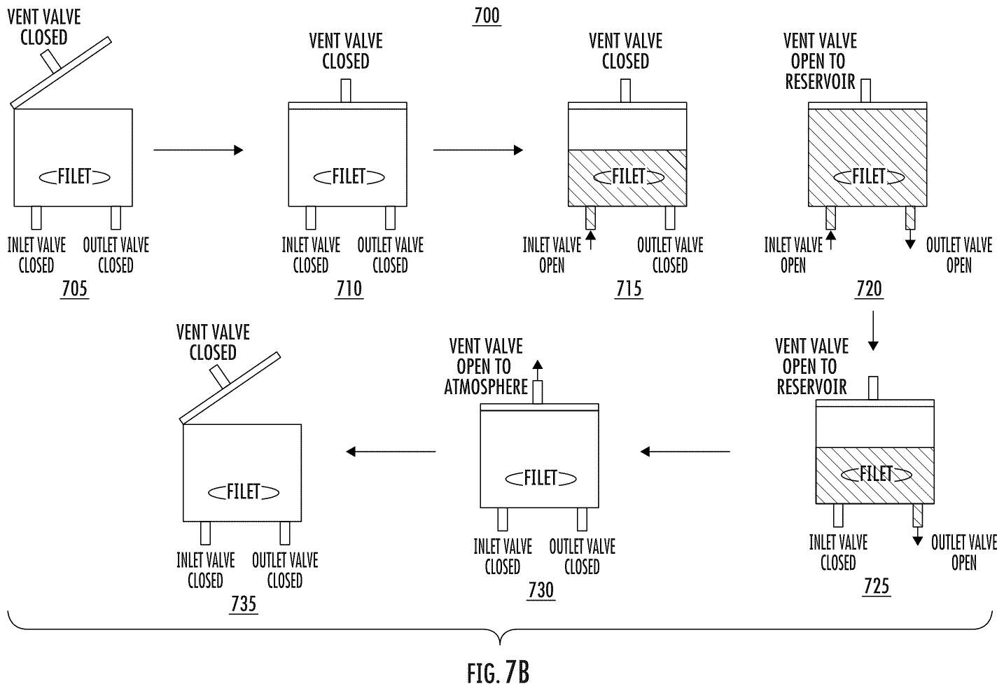

Referring to FIGS. 7A and 7B, an example method of operating the cooking vessels, heated oil reservoirs, and mobile fryer systems described herein is illustrated. That is, FIGS. 7A and 7B illustrate a flowchart containing a series of steps for conducting an example cooking cycle with the mobile fryer system 100, as described above.

In an example embodiment, as shown in step 705, with the valves 202A, 204A, 206A of the cooking vessel 200 closed, the lid 210 of the cooking vessel 200 is opened, enabling access to the cooking chamber 208, and one or more food items 102 are loaded into the empty cooking chamber 208. As described herein, the lid 210 may be a motorized lid. Alternatively, the lid 210 may be opened manually by a food service operator. Alternatively still, the lid 210 may be uncoupled from the cooking vessel 200 via a twist-lock or quarter-turn connection. Such lid 210 may be unlocked and/or opened manually by a food service operator or automatically, such as via a gantry 125. Although this step 705 may be performed while the motor vehicle within which the mobile fryer system 100 is disposed is parked or otherwise not moving, it is contemplated by this disclosure that step 705 may additionally or alternatively be performed in transit (e.g., in a moving motor vehicle) provided the food service operator manually did it safely, such as in an autonomous vehicle or with one or more co-drivers, or the step 705 was performed automatically, such as via a gantry 125.

With continued reference to FIGS. 7A and 7B, in some embodiments, the lid 210 of the cooking vessel 200 is closed with a motor 220 (e.g., a stepper motor, servo motor, etc.) and then locked down as shown in step 710. By way of example, the lid 210 may be locked down using a low-profile air cylinder 216 and lock 212, each of the motor 220 and low-profile air cylinder 216 being communicably coupled to the controller 318 and/or a separate controller to be controlled by such controller. Alternatively still, the lid 210 may be coupled to the cooking vessel 200, either manually or automatically, locking the lid 210 to the cooking vessel 200 via a twist-lock or quarter-turn connection. Such locking features provide an important safety feature by preventing the lid 210 from inadvertently opening or being manually opened by a food service operator at any time during which the cooking vessel 200 may have heated cooking oil 104 contained therein. Such locking feature also enables portions of the cooking cycle to be safely performed in a moving vehicle. For example, steps 705 and 710 may be performed while the vehicle in which the mobile fryer system 100 is disposed is parked (e.g., not in motion). As described herein, the subsequent steps 715, 720, 725 and/or 730 may additionally or alternatively be performed while the vehicle in which the mobile fryer system 100 is disposed is in motion (e.g., traveling from a food service establishment or other remote location to the customer's location), thereby allowing the food to be cooked during transit and delivered to the customer freshly-prepared. In still other embodiments, step 710 may additionally or alternatively be performed in transit (e.g., in a moving motor vehicle) provided the food service operator manually did it safely, such as in an autonomous vehicle or with one or more co-drivers, or the step 705 was performed automatically, such as via a gantry 125.

With continued reference to FIGS. 7A and 7B, as shown in step 715, the inlet valve 202A corresponding to the inlet port 202 may be opened, thereby allowing a flow of heated cooking oil 104 from the heated oil reservoir 300 into the cooking chamber 208 of the cooking vessel 200. As described herein, the inlet valve 202A may optionally be a temperature-sensitive valve for selectively directing the heated cooking oil 104 into the cooking vessel 200 only when the heated cooking oil 104 is within a predefined threshold cooking temperature range. In an instance in which the heated cooking oil 104 satisfies a threshold cooking temperature range, the mobile fryer system 100 may operate to force heated cooking oil 104 through the inlet port 202 of the cooking vessel 200 to at least partially fill the cooking chamber 208.

Thereafter, turning to step 720, the outlet valve 204A corresponding to the outlet port 204 and the headspace venting valve 206A corresponding to the venting port 206 of the cooking vessel 200 are opened to the heated oil reservoir 300, allowing the heated cooking oil 104 to continuously circulate into the cooking vessel 200 via the inlet port 202/inlet valve 202A and out of the cooking vessel 200 via the outlet port 204/outlet valve 204A. Such continuous circulation of heated cooking oil 104 thereby cooks the food item(s) 102 previously loaded in the cooking vessel 200 at step 405. The mobile fryer system 100 may be configured to cease circulation of the heated cooking oil 104 either automatically after a predetermined amount of time, or may be triggered by sensors in the cooking vessel 200 (e.g., a food temperature sensor or the like which determines when the food item 102 is sufficiently cooked). By way of example, the food service operator may enter or identify a cooking time via a user interface (not pictured) associated with the mobile fryer system 100 when loading the food item(s) 102 into the cooking vessel 200 at step 405. Such user interface may be communicably coupled to the controller 318 or a separate controller in order to be controlled by such controller. Additionally or alternatively, the food service operator may enter or identify a type of food item(s) 102 (e.g., fries, chicken filet, etc.), number of food item(s) 102, weight of food item(s) 102, and/or the like when loading the food item(s) 102 into the cooking vessel 200 at step 405. In some embodiments, the mobile fryer system 100 may be configured to continuously circulate the heated cooking oil 104 through the cooking vessel 200 for a programmatically calculated cooking time corresponding to and/or associated with the identified food item type, number of food items 102, and/or weight of food items 102. Additionally or alternatively, in some embodiments, the cooking segment of step 420 may be repeated and/or prolonged, until a sensor (e.g., food temperature sensor) determines that the food item(s) 102 have been sufficiently cooked.

With continued reference to FIGS. 7A and 7B, after the food item(s) 102 are finished cooking in step 720, the inlet valve 202A is closed and the cooking oil 104 is removed and/or drained from the cooking vessel 200 via the open outlet valve 204A/outlet port 204 in step 725. That is, a pump 120 (e.g., drain pump, circulation pump, or the like) may be activated to drain the cooking oil 104 from the cooking vessel 200 through the open outlet valve 204A and back to the heated oil reservoir 300 after completion of the cooking segment in step 720. In some embodiments, the draining segment of step 725 may be repeated and/or prolonged, until a sensor determines that the heated cooking oil 104 has been sufficiently removed and/or drained from the cooking vessel 200. By way of example, a sensor may be disposed within the cooking vessel 200, such as on the interior bottom or interior side wall near the bottom of the cooking chamber 208. In still other embodiments, a sensor may be disposed between the cooking vessel 200 and the heated oil reservoir 300, such as in a drain line providing fluid communication between the outlet port 204 of the cooking vessel 200 and the pump 120 and/or heated oil reservoir 300.

After the cooking oil 104 is sufficiently removed and/or drained from the cooking vessel 200 in step 725, the method continues to step 730, wherein the outlet valve 204A is closed and the atmosphere venting valve 206B is opened to the atmosphere, thereby relieving the pressure from the cooking vessel 200. In some embodiments, the atmosphere venting valve 206B is vented to an external environment of the motor vehicle via a conduit 103.

Such release of pressure allows the lid 210 to be unlocked and safely opened thereafter in step 735. That is, as shown in step 735, the lid 210 of the cooking vessel 200 is unlocked such that the lid 210 can be opened (e.g., manually by the operator, via motor 220, via a gantry 125, etc.). After the lid 210 is opened, the cooked food item(s) 102 may be unloaded by the food service operator and/or the gantry 125 (e.g., using a carrier basket). Although this step 735 may be performed while the motor vehicle within which the mobile fryer system 100 is disposed is parked or otherwise not moving, it is contemplated by this disclosure that step 735 may additionally or alternatively be performed in transit (e.g., in a moving motor vehicle) provided the food service operator did it safely, such as in an autonomous vehicle or with one or more co-drivers.

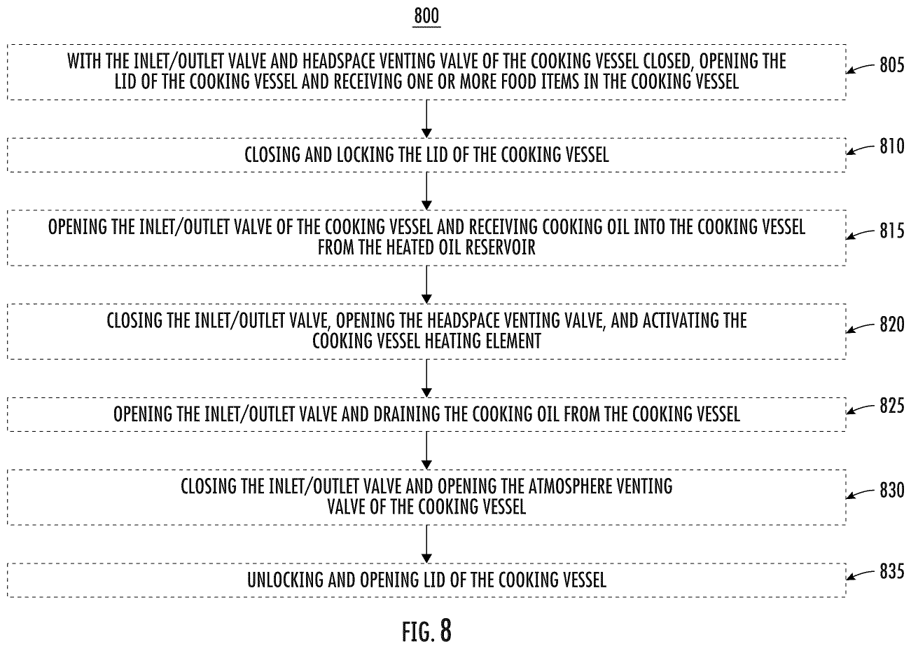

Referring to FIG. 8, another example method of operating the cooking vessels, heated oil reservoirs, and mobile fryer systems described herein is illustrated. That is, FIG. 8 illustrates a flowchart containing a series of steps for conducting an example cooking cycle with the mobile fryer system 1100, as described above. For example, FIG. 8 illustrates a flowchart containing a series of steps for conducting an example cooking cycle with the mobile fryer system as depicted by the flow diagram of FIG. 10.

In an example embodiment, as shown in step 805, with the inlet/outlet valve 1202A and the headspace venting valve 1206A of the cooking vessel 1200 closed, the lid 1210 of the cooking vessel 1200 is opened, enabling access to the cooking chamber 1208, and one or more food items 1102 are loaded into the empty cooking chamber 1208. As described herein, the lid 1210 may be uncoupled from the cooking vessel 1200 via a twist-lock or quarter-turn connection. Such lid 1210 may be unlocked and/or opened manually by a food service operator or automatically, such as via a gantry. Although this step 805 may be performed while the motor vehicle within which the mobile fryer system 1100 is disposed is parked or otherwise not moving, it is contemplated by this disclosure that step 805 may additionally or alternatively be performed in transit (e.g., in a moving motor vehicle) provided the food service operator manually did it safely, such as in an autonomous vehicle or with one or more co-drivers, or the step 805 was performed automatically, such as via a gantry 1125.

With continued reference to FIG. 8, in some embodiments, the lid 1210 of the cooking vessel 1200 is closed and then locked as shown in step 810. By way of example, the lid 1210 may be coupled to the cooking vessel 1200, either manually or automatically, locking the lid 1210 to the cooking vessel 1200 via a twist-lock or quarter-turn connection. Such locking features provide an important safety feature by preventing the lid 1210 from inadvertently opening or being manually opened by a food service operator at any time during which the cooking vessel 1200 may have heated cooking oil 1104 contained therein. Such locking feature also enables portions of the cooking cycle to be safely performed in a moving vehicle. For example, steps 805 and 810 may be performed while the vehicle in which the mobile fryer system 1100 is disposed is parked (e.g., not in motion). As described herein, the subsequent steps 815, 820, 825 and/or 830 may additionally or alternatively be performed while the vehicle in which the mobile fryer system 1100 is disposed is in motion (e.g., traveling from a food service establishment or other remote location to the customer's location), thereby allowing the food to be cooked during transit and delivered to the customer freshly-prepared. In still other embodiments, step 810 may additionally or alternatively be performed in transit (e.g., in a moving motor vehicle) provided the food service operator manually did it safely, such as in an autonomous vehicle or with one or more co-drivers, or the step 805 was performed automatically, such as via a gantry 1125.

With continued reference to FIG. 8, as shown in step 815, the inlet/outlet valve 1202A corresponding to the inlet/outlet port 1202 may be opened, thereby allowing a flow of heated cooking oil 1104 from the heated oil reservoir 1300 into the cooking chamber 1208 of the cooking vessel 1200. As depicted in FIG. 10, the inlet/outlet valves (1202A, 1202B) may be in line between the heated oil reservoir 1300 and the individual cooking vessels (1200A, 1200B). Additionally or alternatively, one or more sensors 1305 may be in line between the heated oil reservoir 1300 and the individual cooking vessels (1200A, 1200B). As described herein, the inlet/outlet valve 1202A may optionally be a temperature-sensitive valve for selectively directing the heated cooking oil 1104 into the cooking vessel 1200 only when the heated cooking oil 104 is within a predefined threshold cooking temperature range. In an instance in which the heated cooking oil 1104 satisfies a threshold cooking temperature range, the mobile fryer system 1100 may operate to force heated cooking oil 1104 through the inlet/outlet port 1202 of the cooking vessel 1200 to at least partially fill the cooking chamber 1208. In some embodiments, the cooking vessel 1200 is initially filled with heated cooking oil 1104 under pressure (e.g., about 10 psi), however, in some further embodiments, the pressure of the cooking vessel 1200 is changed to another pressures, such as atmospheric pressure, at some subsequent point during the cooking cycle (e.g., halfway through the cooking cycle). In some embodiments, the cooking vessel(s) 1200 are at atmospheric pressure and the heated oil reservoir 1300 is pressurized, enabling filling of the cooking vessel(s) 1200 with cooking oil 1104.

Thereafter, turning to step 820, the inlet/outlet valve 1202A is closed, the headspace venting valve 1206A corresponding to the venting port 1206 of the cooking vessel 1200 is opened to the heated oil reservoir 1300, and the cooking vessel heating element 1250 is activated in order to maintain and/or heat the cooking oil 1104 to cook the food item(s) 1102 previously loaded in the cooking vessel 1200 at step 805. The mobile fryer system 1100 may be configured to cease activation of the cooking vessel heating element 1250 either automatically after a predetermined amount of time, or may be triggered by sensors in the cooking vessel 1200 (e.g., a food temperature sensor or the like which determines when the food item 1102 is sufficiently cooked). By way of example, the food service operator may enter or identify a cooking time via a user interface (not pictured) associated with the mobile fryer system 1100 when loading the food item(s) 1102 into the cooking vessel 1200 at step 805. Such user interface may be communicably coupled to the controller 1318 or a separate controller in order to be controlled by such controller. Additionally or alternatively, the food service operator may enter or identify a type of food item(s) 1102 (e.g., fries, chicken filet, etc.), number of food item(s) 1102, weight of food item(s) 1102, and/or the like when loading the food item(s) 1102 into the cooking vessel 1200 at step 805. Such individual control enables multiple cooking vessels 1200 to be operated at different temperatures and/or different cooking times in order to cook different types of food item(s) 1102 to be cooked at the same time in different cooking vessels 1200.

In some embodiments, the mobile fryer system 1100 may be configured to activate the cooking vessel heating element 1250 for a programmatically calculated cooking time corresponding to and/or associated with the identified food item type, number of food items 1102, and/or weight of food items 1102. Additionally or alternatively, in some embodiments, the cooking segment of step 820 may be repeated and/or prolonged, until a sensor (e.g., food temperature sensor) determines that the food item(s) 1102 have been sufficiently cooked.

With continued reference to FIG. 8, after the food item(s) 1102 are finished cooking in step 820, the inlet/outlet valve 1202A is opened and the cooking oil 1104 is removed and/or drained from the cooking vessel 1200 via the open inlet/outlet valve 1202A (i.e., inlet/outlet port 1202) in step 825. That is, a pump 1120 (e.g., drain pump, circulation pump, or the like) may be activated to drain the cooking oil 1104 from the cooking vessel 1200 through the open inlet/outlet valve 1202A and back to the heated oil reservoir 1300 after completion of the cooking segment in step 820.

In some embodiments, the draining segment of step 825 may be repeated and/or prolonged, until a sensor determines that the heated cooking oil 1104 has been sufficiently removed and/or drained from the cooking vessel 1200. By way of example, a sensor may be disposed within the cooking vessel 1200, such as on the interior bottom or interior side wall near the bottom of the cooking chamber 1208. In still other embodiments, a sensor may be disposed between the cooking vessel 1200 and the heated oil reservoir 1300, such as in a drain line providing fluid communication between the inlet/outlet port 1202 of the cooking vessel 1200 and the pump 1120 and/or heated oil reservoir 1300.

After the cooking oil 1104 is sufficiently removed and/or drained from the cooking vessel 1200 in step 825, the method continues to step 830, wherein the inlet/outlet valve 1202A is closed and the atmosphere venting valve 1206B is opened to the atmosphere, thereby relieving the pressure from the cooking vessel 1200. In some embodiments, the atmosphere venting valve 1206B is vented to an external environment of the motor vehicle via a conduit 1103.

Such release of pressure allows the lid 1210 to be unlocked and safely opened thereafter in step 835. That is, as shown in step 835, the lid 1210 of the cooking vessel 1200 is unlocked such that the lid 1210 can be opened (e.g., manually by the operator, automatically via a gantry 1125, etc.). After the lid 1210 is opened, the cooked food item(s) 1102 may be unloaded by the food service operator and/or the gantry 1125 (e.g., using a carrier basket). Although this step 835 may be performed while the motor vehicle within which the mobile fryer system 1100 is disposed is parked or otherwise not moving, it is contemplated by this disclosure that step 835 may additionally or alternatively be performed in transit (e.g., in a moving motor vehicle) provided the food service operator manually did it safely, such as in an autonomous vehicle or with one or more co-drivers, or the step was performed automatically, such as via a gantry 1125.

In this way, the mobile fryer systems 100, 200 of the present application may be installed in or attached to a motor vehicle, thereby operating to cook food item(s) 102, 1102 in one or more cooking vessels 200, 1200 via a cooking cycle, one or more of the segments of the cooking cycle configured to safely occur while in transit to a delivery location such that the cooked food items 102, 1102 are fresh upon delivery.

### Overview of Terms

The following explanations of terms are provided to better describe the present disclosure and to guide those of ordinary skill in the art in the practice of the present disclosure.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described herein. The materials, methods, and examples are illustrative only and not intended to be limiting, unless otherwise indicated. Other features of the disclosure are apparent from the detailed description and the claims.

While the present disclosure has been particularly described in conjunction with specific examples, it is evident that many alternatives, modifications, and variations will be apparent to those skilled in the art in light of the foregoing description. It is therefore contemplated that the appended claims will embrace any such alternatives, modifications, and variations as falling within the present disclosure.

Further, the following exemplary embodiments are provided, the numbering of which is not to be construed as designating levels of importance or relevance:

Embodiment 1 provides a mobile fryer system, the mobile fryer system comprising one or more cooking vessels configured to cook one or more food items via a cooking cycle, each of the one or more cooking vessels comprising a locking lid; a heated oil reservoir defining an enclosure, the enclosure comprising cooking oil; and one or more conduits fluidly connecting the heated oil reservoir to each of the one or more cooking vessels.

Embodiment 2 provides the mobile fryer system of Embodiment 1, wherein each of the one or more cooking vessels comprises a corresponding cooking vessel heating element.

Embodiment 3 provides the mobile fryer system of any one of Embodiments 1-2, wherein at least a first cooking vessel is configured to be adjusted to a different cooking temperature than a second cooking vessel via the respective cooking vessel heating elements.

Embodiment 4 provides the mobile fryer system of any one of Embodiments 1-3, wherein at least one of the one or more cooking vessels comprises an inlet/outlet port, the inlet/outlet port configured to control a flow of the cooking oil into the cooking vessel from the heated oil reservoir, via the one or more conduits.

Embodiment 5 provides the mobile fryer system of any one of Embodiments 1-4, wherein the inlet/outlet port is configured to control a flow of the cooking oil out of the cooking vessel to the heated oil reservoir, via the one or more conduits.

Embodiment 6 provides the mobile fryer system of any one of Embodiments 1-5, wherein the mobile fryer system is installed in or attached to a motor vehicle. I

Embodiment 7 provides the mobile fryer system of any one of Embodiments 1-6, wherein one or more segments of the cooking cycle are configured to occur while the motor vehicle is in transit.

Embodiment 8 provides the mobile fryer system of any one of Embodiments 1-7, wherein the heated oil reservoir is configured to use waste heat from the motor vehicle to heat, at least in part, the cooking oil.

Embodiment 9 provides the mobile fryer system of any one of Embodiments 1-8, wherein the mobile fryer system further comprises a gantry retrieval arm and a gantry drive system operably coupled with the gantry retrieval arm, the gantry drive system configured to cause movement of the gantry retrieval arm.

Embodiment 10 provides the mobile fryer system of any one of Embodiments 1-9, wherein the gantry retrieval arm is configured to engage a corresponding carrier for the automated placement and removal of the food items into and out of the one or more cooking vessels.

Embodiment 11 provides a method of operating a mobile fryer system comprising at least one cooking vessel, each cooking vessel comprising an inlet/outlet valve is provided, the method comprising with the inlet/outlet valve closed, opening a lid of the cooking vessel and placing one or more food items in the cooking vessel; closing and locking the lid; opening the inlet/outlet valve and flowing cooking oil into the cooking vessel from a heated oil reservoir via the inlet/outlet valve; closing the inlet/outlet valve and activating a cooking vessel heating element; opening the inlet/outlet valve and draining the cooking from the cooking vessel via the inlet/outlet valve of the cooking vessel; closing the inlet/outlet valve and opening an atmosphere venting valve of the cooking vessel; and unlocking and opening the lid of the cooking vessel.

Embodiment 12 provides the method of operating a mobile fryer system of Embodiment 11, wherein the mobile fryer system is installed in or attached to a motor vehicle.

Embodiment 13 provides the method of operating a mobile fryer system of any one of Embodiments 11-12, wherein at least the opening the inlet/outlet valve and flowing cooking oil into the cooking vessel from the heated oil reservoir via the inlet/outlet valve occurs while the motor vehicle is in transit.

Embodiment 14 provides the method of operating a mobile fryer system of any one of Embodiments 11-13, wherein at least the closing the inlet/outlet valve and activating a cooking vessel heating element occurs while the motor vehicle is in transit.

Embodiment 15 provides the method of operating a mobile fryer system of any one of Embodiments 11-14, wherein at least the opening the inlet/outlet valve and draining the cooking from the cooking vessel via the inlet/outlet valve occurs while the motor vehicle is in transit.

Embodiment 16 provides the method of operating a mobile fryer system of any one of Embodiments 11-15, wherein the opening the atmosphere venting valve comprising opening the atmosphere venting valve to the atmosphere to relieve pressure from the cooking vessel.

Embodiment 17 provides the method of operating a mobile fryer system of any one of Embodiments 11-16, wherein the cooking oil is flowed into the cooking vessel under approximately 10 psi.

Embodiment 18 provides the method of operating a mobile fryer system of any one of Embodiments 11-17, wherein the lid comprises a twist-lock or quarter-turn connection.

Embodiment 19 provides the method of operating a mobile fryer system of any one of Embodiments 11-18, wherein a top portion of the lid defines one or more interaction points for a corresponding drive motor to interact with and turn the lid.

Embodiment 20 provides the method of operating a mobile fryer system of any one of Embodiments 11-19, wherein the placing one or more food items in the cooking vessel comprises a gantry retrieval arm configured to engage a corresponding carrier for the automated placement of the one or more food items into the cooking vessel, such automated placement occurring while the motor vehicle is in transit.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by interchangeable and/or alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A mobile fryer system comprising:
one or more cooking vessels configured to cook one or more food items via a cooking cycle, each of the one or more cooking vessels comprising a locking lid;
a heated oil reservoir defining an enclosure, the enclosure comprising cooking oil; and
one or more conduits fluidly connecting the heated oil reservoir to each of the one or more cooking vessels.

2. The mobile fryer system of claim 1, wherein each of the one or more cooking vessels comprise a corresponding cooking vessel heating element.

3. The mobile fryer system of claim 2, wherein at least a first cooking vessel is configured to be adjusted to a different cooking temperature than a second cooking vessel via the respective cooking vessel heating elements.

4. The mobile fryer system of claim 1, wherein at least one of the one or more cooking vessels comprises an inlet/outlet port, the inlet/outlet port configured to control a flow of the cooking oil into the cooking vessel from the heated oil reservoir, via the one or more conduits.

5. The mobile fryer system of claim 4, wherein the inlet/outlet port is configured to control a flow of the cooking oil out of the cooking vessel to the heated oil reservoir, via the one or more conduits.

6. The mobile fryer system of claim 1, wherein the mobile fryer system is installed in or attached to a motor vehicle.

7. The mobile fryer system of claim 6, wherein one or more segments of the cooking cycle are configured to occur while the motor vehicle is in transit.

8. The mobile fryer system of claim 6, wherein the heated oil reservoir is configured to use waste heat from the motor vehicle to heat, at least in part, the cooking oil.

9. The mobile fryer system of claim 1, further comprising a gantry retrieval arm and a gantry drive system operably coupled with the gantry retrieval arm, the gantry drive system configured to cause movement of the gantry retrieval arm.

10. The mobile fryer system of claim 9, wherein the gantry retrieval arm is configured to engage a corresponding carrier for the automated placement and removal of the food items into and out of the one or more cooking vessels.

11. A method of operating a mobile fryer system comprising at least one cooking vessel, each cooking vessel comprising an inlet/outlet valve, the method comprising:
with the inlet/outlet valve closed, opening a lid of the cooking vessel and placing one or more food items in the cooking vessel;
closing and locking the lid;
opening the inlet/outlet valve and flowing cooking oil into the cooking vessel from a heated oil reservoir via the inlet/outlet valve;
closing the inlet/outlet valve and activating a cooking vessel heating element;
opening the inlet/outlet valve and draining the cooking from the cooking vessel via the inlet/outlet valve of the cooking vessel;
closing the inlet/outlet valve and opening an atmosphere venting valve of the cooking vessel; and
unlocking and opening the lid of the cooking vessel.

12. The method of claim 11, wherein the mobile fryer system is installed in or attached to a motor vehicle.

13. The method of claim 12, wherein at least the opening the inlet/outlet valve and flowing cooking oil into the cooking vessel from the heated oil reservoir via the inlet/outlet valve occurs while the motor vehicle is in transit.

14. The method of claim 12, wherein at least the closing the inlet/outlet valve and activating a cooking vessel heating element occurs while the motor vehicle is in transit.

15. The method of claim 12, wherein at least the opening the inlet/outlet valve and draining the cooking from the cooking vessel via the inlet/outlet valve occurs while the motor vehicle is in transit.

16. The method of claim 11, wherein the opening the atmosphere venting valve comprising opening the atmosphere venting valve to the atmosphere to relieve pressure from the cooking vessel.

17. The method of claim 11, wherein the cooking oil is flowed into the cooking vessel under approximately 10 psi.

18. The method of claim 11, wherein the lid comprises a twist-lock or quarter-turn connection.

19. The method of claim 18, wherein a top portion of the lid defines one or more interaction points for a corresponding drive motor to interact with and turn the lid.

20. The method of claim 12, wherein the placing one or more food items in the cooking vessel comprises a gantry retrieval arm configured to engage a corresponding carrier for the automated placement of the one or more food items into the cooking vessel, such automated placement occurring while the motor vehicle is in transit.
